(19) United States
(12) Patent Application Publication
(10) Pub. No.: US 2018/0120834 A1
(43) Pub. Date: May 3, 2018

(54) UNMANNED SURFACE VEHICLE

(71) Applicant: JONATHAN GILL, Manchester, NJ (US)

(72) Inventor: JONATHAN GILL, Manchester, NJ (US)

(21) Appl. No.: 15/335,464

(22) Filed: Oct. 27, 2016

(51) Int. Cl. G05D 1/00; G05D 1/02; B62D 55/06; B62D 55/12

(52) U.S. Cl. CPC G05D 1/0038; B62D 55/12; B62D 55/06; G05D 1/0246

(57) ABSTRACT

Disclosed is an unmanned surface vehicle operable remotely by a vehicle operator using a transmitter. The unmanned surface vehicle includes a front section and a rear section, a first left track attached to the housing, a first right track attached to the housing, plurality of first left wheels configured within the first left track, plurality of first right wheels configured within the first right track, a first left motor and a first right motor configured in the housing to drive plurality of first left and first right wheels respectively along with the first left track and the first right track. Further, the unmanned surface vehicle includes a receiver configured in the housing to receive commands from the transmitter, an antenna configured in the housing to amplify the commands received from the transmitter, a first speed controller and a second speed controller to manipulate the speed of the first left motor and the first right motor, respectively on receiving the commands from the transmitter via the receiver. Further, the unmanned surface vehicle includes a power source to power the receiver, the first speed controller and the second speed controller.

### BACKGROUND OF THE INVENTION

### 1. Field of the Invention

The present invention generally relates to a military surface vehicles and more particularly relates to an unmanned surface vehicle capable of remote operation without an onboard operator.

### 2. Description of Related Art

Military operations have evolved to become more sophisticated and technical. One area of improved technology is in the reconnaissance of enemy positions and movements. Tracking is currently done with high altitude, unmanned aircraft, with night vision equipment, heat sensors, parabolic microphones, and through satellite links.

For heavily loaded tracked vehicles, such as large tractors and military tanks, engine power is delivered to respective left and right endless tracks for driving the vehicle. With contemporary communication techniques, the unmanned vehicles may be operated from remote locations, as far as thousands of miles away.

Images of the environment where the unmanned vehicle is operating are acquired by onboard cameras and transmitted to a control center, and instructions are returned to control the actions of the vehicle. Therefore, there is a need of an unmanned vehicle capable of remote operation without an onboard operator. zo Further, the unmanned vehicle should receive power independently for each track.

### SUMMARY OF THE INVENTION

In accordance with the teachings of the present invention, an unmanned vehicle capable of remote operation and generating power independently for each track is provided.

An object of the present invention is to provide an unmanned surface vehicle including a housing having a front section and a rear section, a first left track attached to the housing, a first right track attached to the housing, plurality of first left wheels configured within the first left track, plurality of first right wheels configured within the first right track, a first left motor and a first right motor configured in the housing to drive plurality of first left and first right wheels respectively along with the first left track and the first right track.

Further, the unmanned surface vehicle includes a receiver configured in the housing to receive commands from the transmitter, an antenna configured in the housing to amplify the commands received from the transmitter, a first speed controller and a second speed controller to manipulate the speed of the first left motor and the first right motor, respectively on receiving the commands from the transmitter via the receiver. Further, the unmanned surface vehicle includes a power source to power the receiver, the first speed controller and the second speed controller.

Another object of the present invention is to provide the unmanned surface vehicle with a second left track, a second right track, plurality of second left wheels, plurality of second right wheels, a second left motor, and a second right motor. The first speed controller manipulates the speed of the second left motor, and further the second speed controller manipulates the speed of the second right motor.

Another object of the present invention is to provide the unmanned surface vehicle with a front camera and a rear camera to capture media content of objects from the front section and the rear section, respectively of the housing. Further the vehicle includes a vehicle transmitter to transmit the media content to the transmitter operated by the vehicle operator.

Another object of the present invention is to provide the unmanned surface vehicle with a first left motor shaft for receiving torque and power from the second right motor, a first left gear transmission to receive torque and power from the first left motor shaft, and a first left axle to transfer the receive torque and power from the first left gear transmission to the plurality of first left wheels.

Another object of the present invention is to provide the unmanned surface vehicle includes a second right motor shaft, a second right gear transmission, a second right axle and a first stabilizing plate to stabilize the second right gear transmission and the first left gear transmission for turning the housing.

Further, the unmanned surface vehicle includes a second left motor shaft, a second left gear transmission, a second left axle, a first right motor shaft, a first right gear transmission, a first right axle and a second stabilizing plate to stabilize the first right gear transmission and the second left gear transmission for turning the housing. Further, the unmanned surface vehicle includes a plurality of motion sensors to detect speed and direction of moving objects near to the housing.

These and other features and advantages will become apparent from the following detailed description of illustrative embodiments thereof, which is to be read in connection with the accompanying drawings.

### BRIEF DESCRIPTION OF DRAWINGS

FIG. 1 illustrates a top cross section of an unmanned surface vehicle in accordance with a preferred embodiment of the present invention; and

FIG. 2 illustrates a side view of the unmanned surface vehicle in accordance with a preferred embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF DRAWINGS

While this technology is illustrated and described in a preferred embodiment, an unmanned surface vehicle for receiving operation from a vehicle operator via a transmitter may be produced in many different configurations, shapes, sizes, forms and materials. There is depicted in the drawings, and will herein be described in detail, as a preferred embodiment of the invention, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the technology described herein.

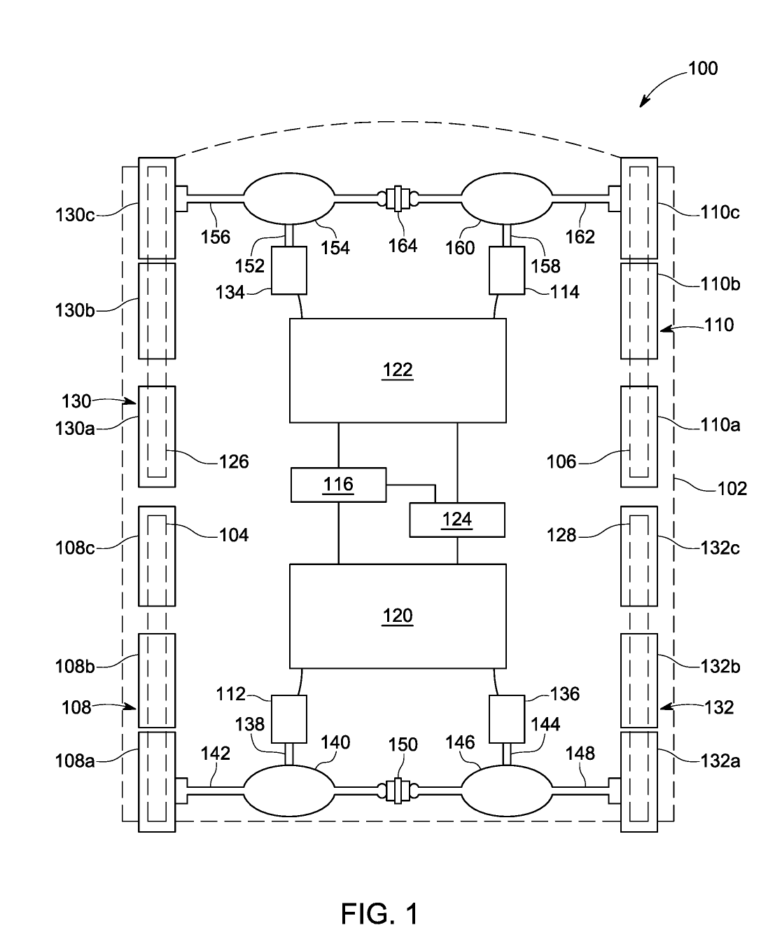

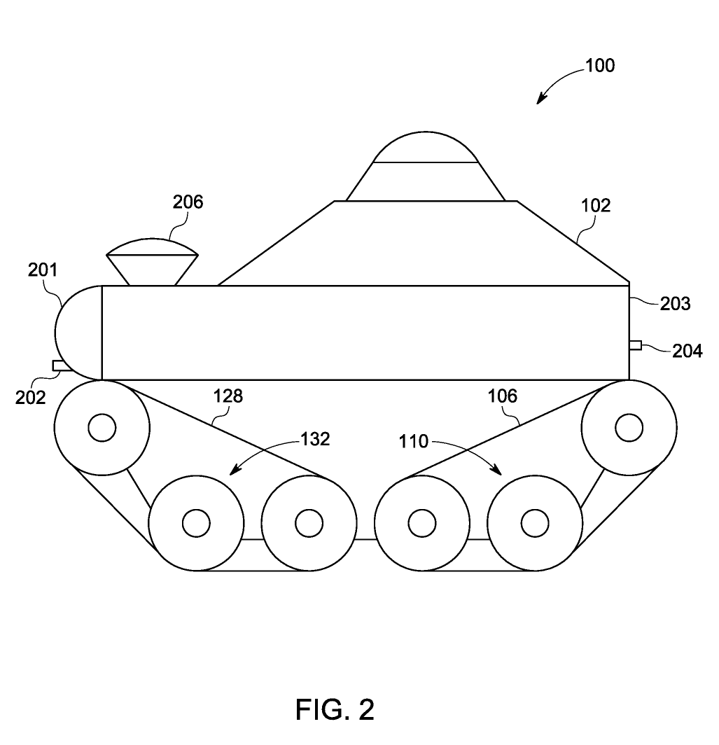

FIG. 1 illustrates a top cross section view of an unmanned surface vehicle 100 for receiving operation from a vehicle operator via a transmitter in accordance with a preferred embodiment of the present invention. The unmanned surface vehicle 100 further includes a housing 102, a first left track 104, a first right track 106, plurality of first left wheels 108 (such as 108a, 108b, 108c), plurality of first right wheels 110 (such as 110a, 110b, 110c), a first left motor 112, a first right motor 114, a receiver 116, an antenna (118, as shown in FIG. 2), a first speed controller 120, a second speed controller 122, and a power source 124.

The first left track 104 is attached to the housing 102 and the plurality of first left wheels 108 configured within the first left track 104. Similarly, the first right track 106 is attached to the housing 102 and the plurality of the first right wheels zo 110 are configured within the first right track 106. The housing 102, the first right track 106, the plurality of first right wheels 110, the antenna 118 are further explained in detailed in conjunction with FIG. 2 of the present invention.

The first left motor 112 is configured in the housing 102 to drive plurality of the first left wheels 108 along with the first left track 104. The first right motor 114 is configured in the housing 102 to drive plurality of the first right wheels 110.along with the first right track 106. Thus, the housing 102 moves on receiving torque and power from the first left motor 112 and the first right motor 114 to drive the plurality of left wheels 108 and plurality of right wheels 110 along with the first left track 104 and the first right track 106, respectively.

The first speed controller 120 is to manipulate the speed of the first left motor 112 on receiving command from the transmitter via the receiver 116. The second speed controller 122 is to manipulate the speed of the first right motor 114 on receiving command from the transmitter via the receiver 116.

In another preferred embodiment of the present invention, the unmanned surface vehicle 100 further includes a second left track 126, a second right track 128, plurality of second left wheels 130 (such as 130a, 130b, 130c), plurality of second right wheels 132 (such as 132a, 132b, 132c), a second left motor 134, and a second right motor 136.

The second left track 126 and the second right track 128 are connected to the housing 102. The plurality of second left wheels 130 and the plurality of second right wheels 132 are configured within the second left track 126 and the second right track 128, respectively.

The second left motor 134 and the second right motor 136 are configured in the housing 102 to drive plurality of second left wheels 130 and the plurality of second right wheels 132, respectively. The first right track 106, the plurality of first right wheels 110, the second right track 128, the plurality of second right wheels 132, and the antenna 118 are further explained in detailed in conjunction with FIG. 2 of the present invention.

The second left motor 134 and the second right motor 136 are configured in the housing 102 to drive the plurality of second left wheels 130 and the plurality of second right wheels 132, respectively. Thus, the housing 102 moves on receiving torque and power from the second left motor 134 and the second right motor 136 in the direction of the rotation of the plurality of second left wheels 130 and the plurality of second right wheels 132.

The first speed controller 120 manipulates the speed of the second right motor 136 and the second speed controller 122 manipulates the speed of the second left motor 134. Further in another preferred embodiment of the present invention, the unmanned surface vehicle 100 includes a first left motor shaft 138, a first left gear transmission 140 and a first left axle 142.

The first left motor shaft 138 receives torque and power from the first left motor 112. The first left gear transmission 140 receives torque and power from the first motor shaft 138. The first left axle 142 transfers the received torque and power from the first left gear transmission 140 to the plurality of first left wheels 108.

Further in another preferred embodiment of the present invention, the unmanned surface vehicle 100 includes a second right motor shaft 144, a second right gear transmission 146, a second right axle 148 and a first stabilizing plate 150. The second right motor shaft 144 receives torque and power from the second right motor 136.

The second right gear transmission 146 receives torque and power from the second motor shaft 144. The second right axle 148 transfers the receive torque and power from the second right gear transmission 146 to the plurality of second right wheels 132. The first stabilizing plate 150 stabilizes the second right gear transmission 146 and the first left gear transmission 140 for turning the housing 102.

Further in another preferred embodiment of the present invention, the unmanned surface vehicle 100 includes a second left motor shaft 152, a second left gear transmission 154, and a second left axle 156. The second left motor shaft 152 receives torque and power from the second left motor 134. The second left gear transmission 154 receives torque and power from the second left motor shaft 152.

The second left axle 156 transfers the receive torque and power from the second left gear transmission 154 to the plurality of second left wheels 130. Further, the unmanned surface vehicle 100 includes a first right motor shaft 158, a first right gear transmission 160, a second right axle 162 and a second stabilizing plate 164.

The first right motor shaft 158 receives torque and power from the first right motor 114. The first right gear transmission 160 receives torque and power from the first right motor shaft 158. The first right axle 162 transfers the receive torque and power from the first right gear transmission 160 to the plurality of first right wheels 110. The second stabilizing plate 164 stabilizes the first right gear transmission 160 and the second left gear transmission 154 for turning the housing 102.

Examples of the receivers 116 include but not limited to JR-PRO-PO RG712BX, RG731BX, RG812BX etc. Examples of the motors 112, 114, 134 and 136 include but not limited to NETGAIN TRANS WARP 9 w/t Optional Tail Shaft Housing, WARP 11 and WARP 13. Examples of the first speed controller 120 and the second speed controller 122 include but not limited to Soltan 1 and Soltan 2.

Examples of the gear transmission 140, 146, 156, 160 include but not limited to one or two or three or four direct gear drive for moving the housing 102. Examples of the stabilizing plate 150 and 164 include but not limited to an housing adapter, reinforcements plates and transducer adapter.

FIG. 2 illustrates a side view of the unmanned surface vehicle 100 in accordance with a preferred embodiment of the present invention. The housing 100 includes a front section 201 and a rear section 203. The unmanned surface vehicle 100 includes a front camera 202, a rear camera 204 and a vehicle transmitter 206. The front camera 202 captures media content from the front section 201 of the housing 102.

The rear camera 204 captures media content of objects from the rear section 203 of the housing 102. The vehicle transmitter 206 transmits the media content captured from the front camera 202 and the rear camera 204 to the transmitter operated by the vehicle operator.

Examples of the front camera 202 and the rear camera 204 include but not limited to thermal camera, a motion camera, a digital camera, a near infrared camera etc. Examples of the vehicle transmitter 206 include but not limited to JR PRO PO 28XDMSS, JR COLT 6 CHANNEL, JR PRO PO 9303 etc.

In a preferred embodiment of the present invention, the first right track 106 and the second right track 128 are also known as tank treads or caterpillar track. The first right track 106 and the second right track 128 are continuous band of treads or track plates driven by plurality of first right wheels 110 and the plurality of second right wheels 132, respectively.

The first left track (104 as shown in FIG. 1) and the second left track (126 as shown in FIG. 1) are created and perform identically to the first right track 106 and the second right track 128. The first left track (104 as shown in FIG. 1), the second left track (126 as shown in FIG. 1), the first right track 106 and the second right track 128 are made of modular steel plates or synthetic rubber reinforced with steel wires.

The plurality of first right wheels 110 and the plurality of second right wheels 132 are also known as road wheel. The plurality of first right wheels 110 and the plurality of second right wheels 132 enable the first right track 106 and the second right track 128, respectively to move smoothly on harsh terrains while absorbing considerable impact.

The plurality of first right wheels 110 and the plurality of second right wheels 132 are made up of metal sheets that are cold pressed using hydraulic presses of up to 3000 tons. The plurality of first left wheels (108 as shown in FIG. 1) and the plurality of second left wheels (130 as shown in FIG. 1) are created and perform identically to the plurality of first right wheels 110 and the plurality of second right wheels 132.

Many changes, modifications, variations and other uses and applications of the subject invention will, however, become apparent to those skilled in the art after considering this specification and the accompanying drawings, which discloses the preferred embodiments thereof. All such changes, modifications, variations and other uses and applications which do not depart from the spirit and scope of the invention are deemed to be covered by the invention, which is to be limited only by the claims which follow.

1. An unmanned surface vehicle for receiving operation from a vehicle operator via a transmitter, the unmanned surface vehicle comprising:
a housing having a front section; and a rear section;
a first left track attached to the housing;
a first right track attached to the housing;
plurality of first left wheels configured within the first left track;
plurality of first right wheels configured within the first right track;
a first left motor configured in the housing to drive plurality of the first left wheels along with the first left track;
a first right motor configured in the housing to drive plurality of first right wheels along with the first right track;
a receiver configured in the housing to receive commands from the transmitter;
an antenna configured in the housing to amplify the commands received from the transmitter;
a first speed controller to manipulate the speed of the first left motor on receiving command from the transmitter via the receiver;
a second speed controller to manipulate the speed of the first right motor on receiving command from the transmitter via the receiver; and
a power source to power the receiver, the first left motor, the right motor, the first speed controller and the second speed controller.

2. The unmanned surface vehicle according to claim 1 further comprising:
a second left track attached to the housing;
a second right track attached to the housing;
plurality of second left wheels configured within the second left track;
plurality of second right wheels configured within the second right track;
a second left motor configured in the housing to drive plurality of second left wheels along with the second left track; and
a second right motor configured in the housing to drive plurality of second right wheels along with the second right track;
wherein the first speed controller manipulates the speed of the second right motor, and further the second speed controller manipulates the speed of the second left motor.

3. The unmanned surface vehicle according to claim 1 further comprising:
a front camera to capture media content from the front section of the housing; and
a rear camera to capture media content of objects from the rear section of the housing;
a vehicle transmitter to transmit the media content captured from the front camera and the rear camera to the transmitter operated by the vehicle operator.

4. The unmanned surface vehicle according to claim 1 further comprising:
a first left motor shaft receives torque and power from the second right motor;
a first left gear transmission to receive torque and power from the first left motor shaft; and
a first left axle to transfer the received torque and power from the first left gear transmission to the plurality of first left wheels.

5. The unmanned surface vehicle according to claim 1 further comprising:
a second right motor shaft receives torque and power from the second right motor;
a second right gear transmission to receive torque and power from the second motor shaft;
a second right axle to transfer the receive torque and power from the second right gear transmission to the plurality of second right wheels; and
a left stabilizing plate to stabilize the second right gear transmission and the first left gear transmission for turning the housing.

6. The unmanned surface vehicle according to claim 1 further comprising:
a second left motor shaft receives torque and power from the second left motor;
a second left gear transmission to receive torque and power from the second left motor shaft; and
a second left axle to transfer the receive torque and power from the second left gear transmission to the plurality of second left wheels.

7. The unmanned surface vehicle according to claim 1 further comprising:
a first right motor shaft receives torque and power from the first right motor;
a first right gear transmission to receive torque and power from the first right motor shaft;
a first right axle to transfer the receive torque and power from the first right gear transmission to the plurality of first right wheels; and
a second stabilizing plate to stabilize the first right gear transmission and the second left gear transmission for turning the housing.

8. The unmanned surface vehicle according to claim 1 further comprising plurality of motion sensors to detect speed and direction of moving objects near to the housing.
